(19) United States
(12) Patent Application Publication
(10) Pub. No.: US 2007/0065677 A1
(43) Pub. Date: Mar. 22, 2007

(54) Magnet, magnet magnetic material, coating film forming treatment liquid, and rotating machine

(76) Inventors: Yuichi Satsu, Hitachi (JP); Matahiro Komuro, Hitachi (JP); Noboru Baba, Hitachiota (JP); Yuzo Kozono, Hitachiota (JP); Kunihiro Maeda, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/524,289

(22) Filed: Sep. 21, 2006

(30) Foreign Application Priority Data
Sep. 21, 2005 (JP) 2005-273054

(51) Int. Cl. B32B 15/00; H01F 1/26; H01F 1/04; H01F 1/00

(52) U.S. Cl. 428/692.1; 252/62.54; 252/62.55; 148/302

(57) ABSTRACT

A magnet, wherein a surface of each of magnetic particles constituting the magnet is covered by a film with two or more types of fluoride are main components, wherein the main components of the film are fluoride including an element selected from the group consisting of Mg, La, Ce, Pr and Nd and fluoride including an element selected from the group consisting of Ca, Sr, Ba, Sm, Eu, Gd, Tb, Dy, Ho, Er, Tm, Yb, or Lu.

### CLAIM OF PRIORITY

The present application claims priority from Japanese application serial No. 2005-273054, filed on September 21, 2005, the contents of which is hereby incorporated by references into this application.

### BACKGROUND OF THE INVENTION

1. Field of Technology

The present invention relates to magnetic materials of magnet, a magnet, treatment liquid for forming coating film and a rotating machine.

2. Background of Art

Conventional rare earth sintered magnets including a fluorine compound are described in Japanese Application Patent Laid-Open Publication No. 2003-282312 (referred to below as Patent Document 1) and Japanese Application Patent Laid-Open Publication No. Hei 10-163055 (referred to below as Patent Document 2). Particularly, according to the technology described in Patent Document 2, a rare earth sintered magnet with a high resistance is achieved by adding CaF₂ powder. In this technology, fluorine compounds form a grain boundary phase in a powder state; forming is not performed along a grain boundary of magnetic particles or powder surfaces. To reduce eddy current, therefore, CaF₂ powder needs to be added until its volume percent becomes near 50% by volume. This makes it inevitable that the magnetic properties are deteriorated.

Patent Document 1 discloses a technology for increasing a coercive force of a rare earth sintered magnet by adding DyF₃ powder. In the technology in Patent Document 1, fluorine compounds form a grain boundary phase in a powder state as in Patent Document 2; forming is not performed along a grain boundary of the magnet or powder surfaces. To increase the coercive force of a rare earth sintered magnet in the technology in Patent Document 1, therefore, DyF₃ powder needs to be added until its volume percent becomes 10% or more by volume. This makes it inevitable that the magnetic flux density of the magnet is lowered, deteriorating the magnetic properties of the magnet.

[Patent Document 1] Japanese Application Patent Laid-Open Publication No. 2003-282312

[Patent Document 21 Japanese Application Patent Laid-Open Publication No. Hei 10-163055

### SUMMARY OF THE INVENTION

In the technology described in Patent Document 2 above, the eddy current in a sintered magnet formed by adding powder for a NdFeB sintered magnet and CaF₂ powder, which is a fluorine compound, can be lowered, but a large amount of CaF2 powder needs to be added; the residual magnetic flux density is largely reduced and the energy product ((BH)_{MAX}), which is a measure of magnet properties, is lowered. Although the eddy current is lowered, the energy product is low, so it is difficult to use this type of magnet in a magnetic circuit that requires a high magnetic flux.

A study by the inventors of the present invention showed that in order to increase an energy product and also increase a resistivity, fluoride coating films can be formed on the surfaces of magnetic particles for a rare earth magnet by immersing the magnetic particles in a type of alcohol or ketone in which rare earth metal fluoride or alkaline earth metal fluoride is swelled. Since it was clarified that rare earth metal fluoride or alkaline earth metal fluoride gel has a zeratinous flex structure and that alcohols and ketones have superior wettability for magnetic particles for rare earth magnets, rare earth fluoride or alkaline earth metal fluoride in high-resistance coating film forming treatment liquid is swelled in a solvent that includes a type of alcohol or ketone as a main component.

Further more, for high-coatability sole-state Mg, La, Ce, Pr, or Nd fluoride, it has been made possible to change gelled metal fluoride to sole by performing ultrasonic agitation together, enabling a nearly transparent or completely transparent solution to be produced. This high-coatability metal fluoride solution was a material optimum for obtaining high wettability and high adhesiveness for surfaces of magnetic particles for rare earth magnets. This high-coatability coating film was optimum as a coating film because rare earth magnet magnetic particles having this coating film on their surfaces were hardly peeled off when a magnet was fabricated.

However, steps for forming a magnet include a step in which heating to 700° C. or higher is performed. Therefore, the high-coatability zol-state metal fluoride described above caused a surface reaction with the rare earth magnet magnetic particles at temperatures of 700° C. or higher, reducing the resistivity. When the volume fraction as a resistive film was lowered to 5% or less by volume, therefore, it was difficult to increase the resistivity as the rare earth magnet to 10 times or more, as compared with a magnet that had no fluoride coating film.

Low-reactivity colloidal fluoride including Ca, Sr, Ba, Sm, Eu, Gd, Tb, Dy, Ho, Er, Tm, Yb, or Lu, that is milled down to an average particle diameter of 10 μm or less, could be crystallized easily for the purpose of lowering reactivity with rare earth magnet magnetic particles. That is, it was found that it is important to lower the amount of alcohol or ketone used to swell fluoride including Ca, Sr, Ba, Sm, Eu, Gd, Tb, Dy, Ho, Er, Tm, Yb, or Lu and that if a proper solvent is selected for the swelling, an amount by which the metal fluoride is swelled can be controlled.

It was also found that only a fraction of the low-reactivity colloidal metal fluoride that is milled down to an average particle diameter of 10 μm or less caused a little surface reaction with rare earth magnet magnetic particles even at temperature of 700° C. or higher, so the fluoride was a superior material as a resistive film. However, the rare earth magnet magnetic particle having the coating film of the low-reactivity colloidal metal fluoride on the surface was easily peeled off when a magnet was fabricated. When the volume fraction as a resistive film was lowered to 5% or less by volume, therefore, it was difficult to increase the resistivity as the rare earth magnet to 10 times or more, as compared with a magnet that has no fluoride coating film.

An object of the present invention is to provide a magnet with high resistivity, a magnetic material for a magnet, coating film forming treatment liquid for use in preparing this type of magnetic material for a magnet and a rotating machine.

A feature of the present invention is that the surface of each of magnetic particles constituting a magnet is covered with a film which includes two or more types of fluoride as main components. This film may also include slight amounts of impurities other than the fluoride. The magnetic particle preferably includes R—Nd—Fe (R is a rare earth element) or R—Co as a main component (95% or more is preferably), but other components may be used as the main component of the magnetic particle.

Another feature of the present invention is a magnetic material for a magnet that includes magnetic particles; a film, main components of which are fluoride including an element selected from the group consisting of Mg, La, Ce, Pr or Nd and fluoride including an element selected from the group consisting of Ca, Sr, Ba, Sm, Eu, Gd, Tb, Dy, Ho, Er, Tm, Yb, or Lu, is formed on a surface of each of the magnetic particles.

Another feature of the present invention is coating film forming treatment liquid; the coating film forming treatment liquid is prepared by dispersing at least two types of fluoride in an solvent; the at least two types of fluoride is fluoride including an element selected from the group consisting of Mg, La, Ce, Pr or Nd and fluoride including an element selected from the group consisting of Ca, Sr, Ba, Sm, Eu, Gd, Tb, Dy, Ho, Er, Tm, Yb, or Lu, the at least two types of fluoride being mixed with each other; the solvent is selected from the group consisting of alcohols and ketones.

Other features of the present invention will be described in the detailed description of the invention in this application.

According to the magnet and the magnetic material for the magnet in the present invention, a magnet with high resistivity and magnetic material for this type of magnet can be provided. According to the coating film forming treatment liquid in the present invention, a magnet with high resistivity and magnetic material for this type of magnet can be prepared.

### BRIEF DESCRIPTION OF THE DRAWINGS

FIG. 1 is a schematic cross-sectional view of a rare earth magnet magnetic particle of the present invention; a high-resistance coating film is formed on the surface by use of high-resistance coating film forming treatment liquid.

FIG. 2 is a schematic cross-sectional view of a rotating machine as an embodiment of the present invention.

FIG. 3 is an internal structure of a magnet of the present invention.

### DETAILED DESCRIPTION OF THE INVENTION

As the magnetic particle used in the present invention, a magnetic particle which includes, for example, R—Fe—B and R—Co (their content is 95% or more) as main components may be used. However, an effect for improving the resistivity in the present invention can be obtained from magnetic particles which include other components as main components. A magnet which includes R—Fe—B (particularly, Nd—Fe—B) and R—Co as main components has a high coercive force and a high residual magnetic flux. To form a coating film including a high-resistance fluoride as a main component on the surface of a magnetic particle, a layer including metal fluoride needs to be formed along the grain boundary or powder surface while the magnetic properties are maintained. The resistivity can be improved even if the layer including fluoride as a main component does not completely cover the magnetic particle, that is, part of the magnetic particle is not covered by the layer. The resistivity can also be improved even if the layer including fluoride as a main component includes a certain amount of substances other than fluoride.

For a NdFeB magnet, Nd₂Fe₁₄B is a main phase, and the Nd phase and the Nd_{1.1}Fe₄B₄ phase exist in a phase diagram. When the NdFeB composition is optimized and NdFeB is heated, a Nd phase or a NdFe alloy phase is formed on the grain boundary. The Nd phase including high-density Nd is oxidized easily, so some oxidized layers are formed. A layer including fluoride is formed outwardly as viewed from the parent phase of the Nd phase, NdFe alloy layer, or Nd oxidized layer. The layer including fluoride includes a phase in which at least one of the alkaline earth metal elements and rare earth elements is combined with fluorine. A layer including fluoride is formed in contact with the above-mentioned Nd₂Fe₁₄B phase, Nd phase, NdFe phase, or Nd oxidized layer. The Nd phase or NdFe phase has a lower melting point than the Nd₂Fe₁₄B phase, so the Nd phase or NdFe phase is diffused more easily when heated and thus the composition changes.

It is important that the average thickness of a layer including fluoride of an alkaline earth element or rare earth element is greater than the thickness of the Nd or NdFe phase or the Nd oxidized layer. When this average thickness is achieved, the eddy current can be reduced and degradation of the magnetic properties can be avoided. The Nd phase or NdFe phase (Nd₉₅Fe₅) is formed on the grain boundary at an eutectic temperature of 665° C. To assure that a layer including fluoride is stable even at this temperature, the layer needs to be thicker than the Nd phase or NdFe phase (Nd₉₅Fe₅). Layers including fluoride can then adjoin the above phase in succession. With this thickness, the thermal stability of the layer including fluoride is increased, making it possible to prevent entry of defects from adjacent layers, discontinuity, and other unstable factors caused by heating. Powder of a highly magnetic material, such as a NdFeB-based material, that includes at least one type of rare earth element is easily oxidized because of the presence of the rare earth element. For easy handling, oxidized powder may be used to fabricate a magnet. As the oxidized layer becomes thick, the magnetic properties deteriorate and the stability of the layer including fluoride is also lowered. When the oxidized layer becomes thick, the layer including fluoride causes a structural change at a heat treatment temperature of 400° C. or higher. Diffusion and conversion into an alloy (diffusion of fluoride and oxide and conversion into an alloy) occur between the layer including fluoride and the oxidized layer.

Next, materials to which the present invention can be applied will be described. A layer including high-coatability zol-state fluorides includes fluorides selected from the group consisting of CaF₂, MgF₂, LaF₃, CeF₃, PrF₃, and NdF₃; amorphous substances made up of these fluorides selected from the group; fluorides made up of a plurality of elements in these fluoride; compound fluorides formed by mixing a minute amount of oxygen, nitrogen, carbon, or another element into these fluorides; fluorides formed by mixing constituent elements, including impurities, included in the main phase into these fluorides; or fluorides having a low fluorine concentration than the above-mentioned fluorides. A layer including low-reactivity sol-state colloidal fluorides that are milled down to an average particle diameter of 10 μm or less includes fluorides selected from the group consisting of SmF₃, EuF₃, GdF₃, TbF₃, DyF₃, HoF₃, ErF₃. TmF₃, YbF₃, and LuF₃; amorphous substances made up of fluorides selected from the group; fluorides made up of a plurality of elements in these fluorides; compound fluorides formed by mixing a minute amount of oxygen, nitrogen, carbon, or another element into these fluorides; fluorides formed by mixing constituent elements, including impurities, included in the main phase into these fluorides; or fluorides having a low fluorine concentration than the above-mentioned fluorides.

To form a uniform layer including these fluorides, an applying method in which a solution is used can be effectively practiced for surfaces of particles exhibiting strong magnetism. In view that rare earth magnet magnetic particles are extremely easy to collide, a technique for using a spattering method or vapor deposition method to form metal fluoride can be used. However, additional work is required to obtain metal fluoride with a uniform thickness, resulting in a high cost. A wet method in which a water solution is used is not suitable because rare earth magnet magnetic particles easily produce rare earth oxides. In the present invention, it was found that when a solution a main component of which is alcohol or ketone, which has high wettability for rare earth magnet magnetic particles and allows as many ion components as possible to be removed, is used, corrosion (oxidation) of rare earth magnet magnetic particles is suppressed and application of metal fluoride is possible.

When an object of applying metal fluoride to rare earth magnet magnetic particles is considered, metal fluoride in a solid state is not suitable. This is because when metal fluoride in a solid state is applied to rare earth magnet magnetic particles, the metal fluoride does not produce continuous films on surfaces of the rare earth magnet magnetic particles. In the present invention, noting that when hydrofluoric acid is added to a solution including rare earth ions and alkaline earth ions, a sol-gel reaction occurs, it was found that water used as a solvent can be replaced with alcohol or ketone and ion components can be removed. For high-coatability sol-state fluoride including Mg, La, Ce, Pr, or Nd, it was also found that gelled metal fluoride can be changed to sole by performing ultrasonic agitation together and thereby the resulting fluoride is a material optimum for obtaining high wettability and high adhesiveness for surfaces of rare earth magnet magnetic particles. For low-reactivity colloidal fluoride including Ca, Sr, Ba, Sm, Eu, Gd, Tb, Dy, Ho, Er, Tm Yb, or Lu that is milled down to an average particle diameter of 10 μm or less, it is important that the fluoride can be crystallized easily so as to lower reactivity with rare earth magnet magnetic particles. The term “low reactivity” is used here to refer to a nature in which components of magnetic particles are not eluted easily during heat-caused surface reaction of magnetic particles. That is, it is important to lower the amount of alcohol or ketone used to swell a fluoride including Ca, Sr, Ba, Sm, Eu, Gd, Tb, Dy, Ho, Er, Tm, Yb, or Lu. It was found, to achieve this, if a proper solvent is selected for the swelling, an amount by which the metal fluoride is swelled can be controlled. Sr and Ba fluorides can be considered to have a similar effect because, as with Mg and Ca, Sr and Ba are alkaline earth metals. Since the low-reactivity colloidal metal fluoride described above is mixed with high-coatability sol-state metal fluoride, the low-reactivity colloidal metal fluoride and high-coatability sol-state metal fluoride are required to be highly compatible with each other and have high dispersibility. Therefore, it is important to prepare low-reactivity colloidal metal fluoride and high-coatability sol-state metal fluoride by using solvents having the same composition. To precisely control solvents' physical properties, solvents in which various types of alcohol or ketone are mixed are useful. High-resistance coating film forming treatment liquid resulting from the mixing of the high-coatability sol-state metal fluoride and low-reactivity colloidal metal fluoride prepared as described above is easily applied to rare earth magnet magnetic particles, and can be used to form continuous coating films made up of metal fluoride on the surfaces of rare earth magnet magnetic particles. Furthermore, it has been made possible that a rare earth magnet fabricated by use of the rare earth magnet magnetic particles on which high-resistance coating films are formed has a resistance 10 times or higher than rare earth magnets that lack high-resistance coating films, without the magnetic properties being deteriorated.

A layer including metal fluoride can be formed in both processes after and before heat treatment performed for a high coercive force. After the surface of a rare earth magnet magnetic particle is covered by a layer including fluoride, magnetic field orientation is performed and then hot forming is performed to fabricate an anisotropic magnet. An isotropic magnet can also be fabricated without a magnetic field for providing anisotropism being applied. Highly magnetic materials including rare earth elements that can be used include Nd₂Fe₁₄B, (Nd, Dy)₂Fe₁₄B, Nd₂(Fe, Co)₁₄B, and (Nd, Dy)₂(Fe, Co)₁₄B; powder formed by adding Ga, Mo, V, Cu, Zr, Tb, and Pr to these NdFeB substances; Sm₂Co₁₇-based Sm₂(Co, Fe, Cu, Zr)₁₇; or Sm₂Fe₁₇N₃.

The inventors made an earnest study of increasing the resistance of a magnet fabricated by use of rare earth magnet magnetic particles the surfaces of which are covered by coating films, without the volume fraction being increased. The result showed that a high-resistance rare earth magnet having magnetic properties that are not deteriorated when the volume fraction of the coating films is lowered can be fabricated; this type of magnet was fabricated by use of rare earth magnet magnetic particles, on the surfaces of which coating films are formed by use of coating film forming treatment liquid, which is a mixture of high-coatability sol-state fluoride including Mg, La, Ce, Pr, or Nd and low-reactivity colloidal fluoride including Ca, Sr, Ba, Sm, Eu, Gd, Tb, Dy, Ho, Er, Tm Yb, or Lu that is milled down to an average particle diameter of 10 μm or less. This was achieved because the high-coatability sol-state fluoride including Mg, La, Ce, Pr, or Nd functioned as a superior adhesive when the low-reactivity colloidal fluoride including Ca, Sr, Ba, Sm, Eu, Gd, Tb, Dy, Ho, Er, Tm Yb, or Lu is coated on the surfaces of rare earth magnet magnetic particles. Specifically, a low-reactivity fluoride coating material functions as an adhesive for high-coatability fluoride coating material and prevents the fluoride coating material from dropping from magnetic particles.

Since the low-reactivity colloidal metal fluoride is mixed with high-coatability sol-state metal fluoride, it was important that the low-reactivity colloidal metal fluoride and high-coatability sol-state metal fluoride are highly compatible with each other and have high dispersibility. Therefore, it is important to prepare low-reactivity colloidal metal fluoride and high-coatability sol-state metal fluoride by using solvents with the same composition. To precisely control solvents' physical properties, solvents in which various types of alcohol or ketone are mixed are useful. High-resistance coating film forming treatment liquid resulting from the mixing of high-coatability sol-state metal fluoride and low-reactivity colloidal metal fluoride prepared as described above is easily applied to rare earth magnet magnetic particles, and can be used to form continuous coating films made up of metal fluoride on the surfaces of rare earth magnet magnetic particles. Furthermore, a rare earth magnet fabricated by use of the rare earth magnet magnetic particles on which high-resistance coating films are formed could have a resistance 10 times or higher than rare earth magnets that lack high-resistance coating films, without the magnetic properties being deteriorated. The low-reactivity colloidal metal fluorides need to be milled down to an average particle diameter of 10 μm to an nm level so that the coating films formed on the surfaces of rare earth magnet magnetic particles have a uniform thickness with ease. Since a solvent including alcohol or ketone as a main component is used, oxidization of rare earth magnet magnetic particles, which would otherwise be oxidized extremely easily, can be suppressed. In the solvent as the coating film forming treatment liquid, the number of carbons is 4 or less.

The concentrations of the high-coatability sol-state metal fluoride and low-reactivity colloidal metal fluoride depend on the thickness of the film formed on the surface of the rare earth magnet magnetic particle. Rare earth fluoride or alkaline earth metal fluoride is swelled in a solvent including alcohol or ketone as a main component, and the high-coatability sol-state metal fluoride that is in the gel state, and the low-reactivity colloidal metal fluoride are milled down to an average particle diameter of 10 μm to an nm level and dispersed in the solvent including alcohol or ketone as a main component. To maintain the dispersed state, there are upper limits for the concentration of the high-coatability sol-state metal fluoride and low-reactivity colloidal metal fluoride. Although the upper concentration limits will be described in an embodiment below, when high-coatability sol-state metal fluoride and low-reactivity colloidal metal fluoride are swelled in a solvent including alcohol or ketone as a main component, the concentrations of the high-coatability sol-state metal fluoride and low-reactivity colloidal metal fluoride in the solvent are 300 g/dm³ to 10 g/dm³. Similarly, as for a solution in which the high-coatability sol-state metal fluoride and low-reactivity colloidal metal fluoride are mixed, the metal fluoride concentration is also 300 g/dm³ to 10 g/dm³.

The amount of high-resistance coating film forming treatment liquid to be added depends on the average particle diameter of rare earth magnet magnetic particles. When the average particle diameter of rare earth magnet magnetic particles is 0.1 to 500 μm, 300 to 10 ml is preferable for 1 kg of rare earth magnet magnetic particles. If the amount of treatment liquid is large, not only does a time to remove the solvent become long but also rare earth magnet magnetic particles are corroded easily. If the amount of treatment liquid is small, some portions on the surfaces of the rare earth magnet magnetic particles are not wetted by the treatment liquid.

Rare earth magnet magnetic particles are applicable to all materials that include rare earth elements such as Nd—Fe—B materials, Sm—Fe—N materials, and Sm—Co materials.

### First Embodiment

A key point in this embodiment lies in that high-coatability sol-state fluoride and low-reactivity metal fluoride are mixed in a coating film that coats a magnetic particle. This improves the resistivity of a sintered magnet. Liquid for treatment of high-coatability sol-state fluoride including Mg, La, Ce, Pr, or Nd was prepared as follows:

(1) Four grams of La acetate or La nitrate, which is salt with high solubility when La is used as an example, was added to 100 mL of water. The salt was completely dissolved by using a shaker or ultrasonic agitator.

(2) Hydrofluoric acid diluted to 10% was gradually added by an equivalent for a chemical reaction by which LaF₃ is created.

(3) The solution in which gelled LaF₃ was precipitated was agitated by an ultrasonic agitator for one hour or more.

(4) Centrifugal separation was performed at a rotational speed of 4000 to 6000 rpm. Then supernatant fluid was removed and methanol was added by almost the same amount.

(5) The methanol solution including gelled LaF₃ was agitated to form a complete suspension. The suspension was agitated by an ultrasonic agitator for one hour or more.

(6) Centrifugal separation was performed at a rotational speed of 4000 to 6000 rpm. Then supernatant fluid was removed and methanol, ethanol, n-propyl alcohol, isopropyl alcohol, acetone, or 2-butanone was added by almost the same amount. In the steps that follow, ethanol is used as an example.

(7) The ethanol solution including gelled LaF₃ was agitated to form a complete suspension. The suspension was agitated by an ultrasonic agitator for one hour or more.

(8) Operation in (6) and (7) was repeated 3 to 10 times until negative ions such as acetate ions or nitrate ions were no longer detected.

(9) For LaF₃, almost transparent sol-state LaF₃, was finally obtained. An ethanol solution including LaF₃ with a concentration of 3 g/10 mL was used as the treatment liquid.

Table 1-(1) list other liquids used for treatment of high-coatability sol-state metal fluorides including Mg, Ce, Pr, and Nd.

TABLE 1-(1)
Treatment liquids for forming coating films from
rare earth fluoride and alkaline earth fluoride

| | | Effective | | | |
|---|---|---|---|---|---|
| | | concentration as | | Average particle | |
| Component | Treatment liquid state | treatment liquid | Solvent | diameter | |
| MgF₂ | Transparent and colorless, | ≦300 g/dm³ | Methyl alcohol | <100 | nm |
| | slightly viscous | | | | |
| | Transparent and colorless, | ≦300 g/dm³ | Ethyl alcohol | <100 | nm |
| | slightly viscous | | | | |
| | Transparent and colorless, | ≦300 g/dm³ | n-propyl alcohol | <100 | nm |
| | slightly viscous | | | | |
| | Transparent and colorless, | ≦300 g/dm³ | Isopropyl alcohol | <100 | nm |
| | slightly viscous | | | | |
| | Transparent and colorless, | ≦300 g/dm³ | Acetone | <100 | nm |
| | slightly viscous | | | | |
| | White turbidity, slightly | ≦300 g/dm³ | 2-butanone | <100 | nm |
| | viscous | | | | |
| CaF₃ | Translucence | ≦300 g/dm³ | Methyl alcohol | 100 to 3000 | nm |
| | Translucence | ≦300 g/dm³ | Ethyl alcohol | 100 to 2000 | nm |
| | Slightly viscous | ≦300 g/dm³ | n-propyl alcohol | 100 to 1000 | nm |
| | Slightly viscous | ≦300 g/dm³ | Isopropyl alcohol | 100 to 1000 | nm |
| | White turbidity | ≦300 g/dm³ | Acetone | 100 to 10000 | nm |
| | White turbidity | ≦300 g/dm³ | 2-butanone | 100 to 10000 | nm |
| LaF₃ | Slightly viscous | ≦300 g/dm³ | Methyl alcohol | 100 to 1000 | nm |
| | Translucence | ≦300 g/dm³ | Ethyl alcohol | 100 to 2000 | nm |
| | White turbidity | ≦300 g/dm³ | n-propyl alcohol | 100 to 3000 | nm |
| | White turbidity | ≦300 g/dm³ | Isopropyl alcohol | 100 to 3000 | nm |
| | White turbidity | ≦300 g/dm³ | Acetone | 100 to 10000 | nm |
| | White turbidity | ≦300 g/dm³ | 2-butanone | 100 to 10000 | nm |
| CeF₃ | Slightly viscous | ≦100 g/dm³ | Methyl alcohol | 100 to 1000 | nm |
| | Vicious, White turbidity | ≦100 g/dm¹ | Ethyl alcohol | 100 to 2000 | nm |
| | White turbidity | ≦200 g/dm¹ | n-propyl alcohol | 100 to 3000 | nm |
| | White turbidity | ≦200 g/dm³ | Isopropyl alcohol | 100 to 3000 | nm |
| | White turbidity | ≦200 g/dm³ | Acetone | 100 to 10000 | nm |
| | White turbidity | ≦200 g/dm³ | 2-butanone | 100 to 10000 | nm |
| PrF₃ | Greenish yellow | ≦100 g/dm³ | Methyl alcohol | 100 to 1000 | nm |
| | translucence, viscous | | | | |
| | Greenish yellow turbidity, | ≦100 g/dm³ | Ethyl alcohol | 100 to 2000 | nm |
| | viscous | | | | |
| | Greenish yellow turbidity | ≦200 g/dm³ | n-propyl alcohol | 100 to 3000 | nm |
| | Greenish yellow turbidity | ≦200 g/dm³ | Isopropyl alcohol | 100 to 3000 | nm |
| | Greenish yellow turbidity | ≦200 g/dm³ | Acetone | 100 to 10000 | nm |
| | Greenish yellow turbidity | ≦200 g/dm³ | 2-butanone | 100 to 10000 | nm |
| NdF₃ | Pale purple translucence, | ≦200 g/dm³ | Methyl alcohol | 100 to 1000 | nm |
| | viscous | | | | |
| | Pale purple turbidity, | ≦200 g/dm³ | Ethyl alcohol | 100 to 2000 | nm |
| | viscous | | | | |
| | Pale purple turbidity | ≦200 g/dm³ | n-propyl alcohol | 100 to 3000 | nm |
| | Pale purple turbidity | ≦200 g/dm³ | Isopropyl alcohol | 100 to 3000 | nm |
| | Pale purple turbidity | ≦200 g/dm³ | Acetone | 100 to 10000 | nm |
| | Pale purple turbidity | ≦200 g/dm³ | 2-butanone | 100 to 10000 | nm |
| SmF₃ | White turbidity | ≦300 g/dm³ | Methyl alcohol | 100 to 2000 | nm |
| | White turbidity | ≦300 g/dm³ | Ethyl alcohol | 100 to 3000 | nm |
| | White turbidity | ≦200 g/dm³ | n-propyl alcohol | 100 to 10000 | nm |
| | White turbidity | ≦200 g/dm³ | Isopropyl alcohol | 100 to 10000 | nm |
| | White turbidity | ≦200 g/dm³ | Acetone | 100 to 10000 | nm |
| | White turbidity | ≦200 g/dm³ | 2-butanone | 100 to 10000 | nm |
| EuF₃ | White turbidity | ≦300 g/dm³ | Methyl alcohol | 100 to 2000 | nm |
| | White turbidity | ≦300 g/dm³ | Ethyl alcohol | 100 to 3000 | nm |
| | White turbidity | ≦200 g/dm³ | n-propyl alcohol | 100 to 10000 | nm |
| | White turbidity | ≦200 g/dm³ | Isopropyl alcohol | 100 to 10000 | nm |
| | White turbidity | ≦200 g/dm³ | Acetone | 100 to 10000 | nm |
| | White turbidity | ≦200 g/dm³ | 2-butanone | 100 to 10000 | nm |

TABLE 1-(2)
Treatment liquids for forming coating films from
rare earth fluoride and alkaline earth fluoride

| | | Effective | | | |
|---|---|---|---|---|---|
| | | concentration as | | Average particle | |
| Component | Treatment liquid state | treatment liquid | Solvent | diameter | |
| GdF₃ | White turbidity | ≦300 g/dm³ | Methyl alcohol | 100 to 2000 | nm |
| | White turbidity | ≦300 g/dm³ | Ethyl alcohol | 100 to 3000 | nm |
| | White turbidity | ≦200 g/dm³ | n-propyl alcohol | 100 to 10000 | nm |
| | White turbidity | ≦200 g/dm³ | Isopropyl alcohol | 100 to 10000 | nm |
| | White turbidity | ≦200 g/dm³ | Acetone | 100 to 10000 | nm |
| | White turbidity | ≦200 g/dm³ | 2-butanone | 100 to 10000 | nm |
| TbF₃ | White turbidity | ≦300 g/dm³ | Methyl alcohol | 100 to 2000 | nm |
| | White turbidity | ≦300 g/dm³ | Ethyl alcohol | 100 to 3000 | nm |
| | White turbidity | ≦200 g/dm³ | n-propyl alcohol | 100 to 10000 | nm |
| | White turbidity | ≦200 g/dm³ | Isopropyl alcohol | 100 to 10000 | nm |
| | White turbidity | ≦200 g/dm³ | Acetone | 100 to 10000 | nm |
| | White turbidity | ≦200 g/dm³ | 2-butanone | 100 to 10000 | nm |
| DyF₃ | White turbidity | ≦300 g/dm³ | Methyl alcohol | 100 to 2000 | nm |
| | White turbidity | ≦300 g/dm³ | Ethyl alcohol | 100 to 3000 | nm |
| | White turbidity | ≦200 g/dm³ | n-propyl alcohol | 100 to 10000 | nm |
| | White turbidity | ≦200 g/dm³ | Isopropyl alcohol | 100 to 10000 | nm |
| | White turbidity | ≦200 g/dm³ | Acetone | 100 to 10000 | nm |
| | White turbidity | ≦200 g/dm³ | 2-butanone | 100 to 10000 | nm |
| HoF₂ | Peach turbidity | ≦300 g/dm³ | Methyl alcohol | 100 to 2000 | nm |
| | Peach turbidity | ≦300 g/dm³ | Ethyl alcohol | 100 to 3000 | nm |
| | Peach turbidity | ≦200 g/dm³ | n-propyl alcohol | 100 to 10000 | nm |
| | Peach turbidity | ≦200 g/dm³ | Isopropyl alcohol | 100 to 10000 | nm |
| | Peach turbidity | ≦200 g/dm³ | Acetone | 100 to 10000 | nm |
| | Peach turbidity | ≦200 g/dm³ | 2-butanone | 100 to 10000 | nm |
| ErF₃ | Peach turbidity | ≦300 g/dm³ | Methyl alcohol | 100 to 2000 | nm |
| | Peach turbidity | ≦300 g/dm³ | Ethyl alcohol | 100 to 3000 | nm |
| | Peach turbidity | ≦200 g/dm³ | n-propyl alcohol | 100 to 10000 | nm |
| | Peach turbidity | ≦200 g/dm³ | Isopropyl alcohol | 100 to 10000 | nm |
| | Peach turbidity | ≦200 g/dm³ | Acetone | 100 to 10000 | nm |
| | Peach turbidity | ≦200 g/dm³ | 2-butanone | 100 to 10000 | nm |
| TmF₃ | Slightly translucence, | ≦200 g/dm³ | Methyl alcohol | 100 to 1000 | nm |
| | viscous | | | | |
| | White turbidity | ≦200 g/dm³ | Ethyl alcohol | 100 to 3000 | nm |
| | White turbidity | ≦200 g/dm³ | n-propyl alcohol | 100 to 10000 | nm |
| | White turbidity | ≦200 g/dm³ | Isopropyl alcohol | 100 to 10000 | nm |
| | White turbidity | ≦200 g/dm³ | Acetone | 100 to 10000 | nm |
| | White turbidity | ≦200 g/dm³ | 2-butanone | 100 to 10000 | nm |
| YbF₃ | Slightly translucence, | ≦200 g/dm³ | Methyl alcohol | 100 to 1000 | nm |
| | viscous | | | | |
| | White turbidity | ≦200 g/dm³ | Ethyl alcohol | 100 to 3000 | nm |
| | White turbidity | ≦200 g/dm³ | n-propyl alcohol | 100 to 10000 | nm |
| | White turbidity | ≦200 g/dm³ | Isopropyl alcohol | 100 to 10000 | nm |
| | White turbidity | ≦200 g/dm³ | Acetone | 100 to 10000 | nm |
| | White turbidity | ≦200 g/dm³ | 2-butanone | 100 to 10000 | nm |
| LuF₃ | Slightly translucence, | ≦200 g/dm³ | Methyl alcohol | 100 to 1000 | nm |
| | viscous | | | | |
| | White turbidity | ≦200 g/dm³ | Ethyl alcohol | 100 to 3000 | nm |
| | White turbidity | ≦200 g/dm³ | n-propyl alcohol | 100 to 10000 | nm |
| | White turbidity | ≦200 g/dm³ | Isopropyl alcohol | 100 to 10000 | nm |
| | White turbidity | ≦200 g/dm³ | Acetone | 100 to 10000 | nm |
| | White turbidity | ≦200 g/dm³ | 2-butanone | 100 to 10000 | nm |

Liquid for treatment of low-reactivity colloidal fluoride including Ca, Sr, Ba, Sm, Eu, Gd, Tb, Dy, Ho, Er, Tm, Yb, or Lu was prepared as follows:

(10) Four grams of Ho acetate or Ho nitrate, which is salt with high solubility when Ho is used as an example, was added to 100 mL of water. The salt was completely dissolved by using a shaker or ultrasonic agitator.

(11) Hydrofluoric acid diluted to 10% was gradually added by an equivalent for a chemical reaction by which HoF₃ is created.

(12) The solution in which gelled HoF₃ was precipitated was agitated by an ultrasonic agitator for one hour or more.

(13) Centrifugal separation was performed at a rotational speed of 4000 to 6000 rpm. Then supernatant fluid was removed and methanol was added by almost the same amount.

(14) The methanol solution including gelled HoF₃ was agitated to form a complete suspension. The suspension was agitated by an ultrasonic agitator for one hour or more.

(15) Centrifugal separation was performed at a rotational speed of 4000 to 6000 rpm. Then supernatant fluid was removed and methanol, ethanol, n-propyl alcohol, isopropyl alcohol, acetone, or 2- butanone was added by almost the same amount. In the steps that follow, ethanol is used as an example.

(16) The methanol solution including gelled HoF₃ was agitated to form a complete suspension. The suspension was agitated by an ultrasonic agitator for one hour or more.

(17) Operation in (15) and (16) was repeated 3 to 10 times until negative ions such as acetate ions or nitrate ions were no longer detected.

(18) For HoF₃, almost peach turbidity HoF₃ was finally obtained. An ethanol solution including HoF₃ with a concentration of 3 g/10 mL was used as the treatment liquid.

As with high-coatability sol-state metal fluorides, Table 1-(2) list other liquids used for treatment of low-reactivity colloidal fluorides including Sr, Ba, Sm, Eu, Gd, Tb, Dy, Ho, Er, Tm, Yb, or Lu.

High-resistance coating film forming treatment liquid was prepared as follows. In the example below, LaF₃ is used as high-coatability sol-state metal fluorides, and HoF₃ is used as low-reactivity colloidal metal fluoride.

(19) The LaF₃ solution with a concentration of 3 g/10 mL in which ethanol was used as an solvent, prepared in (9), and the HoF₃ solution with a concentration of 3 g/10 mL in which ethanol was used as an solvent, prepared in (18), were mixed and agitated by an ultrasonic agitator for one hour or more. The resulting solution was used as high-resistance coating film forming treatment liquid.

Next, NdFeB alloy powder was used as rare earth magnet magnetic particles. The magnetic particles have an average particle diameter of 70 μm, and is magnetically anisotropic. Processes for forming high-resistance coating films on rare earth magnet magnetic particles were conducted by the method described below.

In the following embodiment, a mixed solution in which 3 g/10 mL of LaF₃ and 3 g/10 mL of HoF₃ were mixed in an ethanol solvent was used as high-resistance coating film forming treatment liquid.

(1) Ten mL of high-resistance coating film forming treatment liquid was added to 100 g of rare earth magnet magnetic particles having an average particle diameter of 70 μm. Mixing was performed until it was confirmed that the entire rare earth magnet magnetic particles were wetted.

(2) The rare earth magnet magnetic particles, obtained in (1), on which high-resistance coating films were formed, were placed under a reduced pressure of 2 to 5 torr to remove the ethanol solvent.

(3) The rare earth magnet magnetic particles from which the solvent was removed in (2) was moved to a quartz board, and then heated at 200° C. for 30 minutes and at 400° C. for 30 minutes, under a reduced pressure of 1×10⁻⁵ torr.

(4) The magnetic particles, for which heat treatment was performed in (3), were moved to a covered container made of Macor (from Riken Denshi, Co., Ltd.), and then heated at 800° C. for 30 minutes under a reduced pressure of 1×10⁻⁵ torr.

(5) The magnetic properties of the rare earth magnet magnetic particles, for which heat treatment were performed in (4), were investigated.

(6) The rare earth magnet magnetic particles, for which heat treatment was performed in (3), were loaded into a metal mold, and orientation was performed in a 10-kOe magnetic field in an inert gas atmosphere. Then, heated compression molding was performed under a molding pressure of 5 t/cm². An anisotropic magnet measuring 7 mm×7 mm×5 mm was fabricated under a molding condition of 700° C. Then, the anisotropic magnet was heated at 800° C. for 30 minutes.

(7) A pulse magnetic field at 30 kOe or more was applied to the anisotropic magnet fabricated in (6) in the anisotropic direction. The magnetic properties of the magnet were then investigated.

Table 2 shows results obtained by investigating the magnetic properties of magnets and magnetic particles fabricated in processes (1) to (7) above by using other high-resistance coating film forming treatment liquids. For comparison purposes, a sintered magnet fabricated from magnetic particles without high-resistance coating films is shown at the line 1 in Table 2. Also for comparison purposes, Table 4 shows the properties of a sintered magnet fabricated from magnetic particles with coating films formed from only one type of fluoride.

TABLE 2
Magnetic properties of magnets using magnetic particles with coating
films formed from rare earth fluoride and alkaline earth fluoride

| | | | | | Treatment | | |
|---|---|---|---|---|---|---|---|
| | | | | | liquid to be | | Magnetic properties of |
| | | | | | added to 100 g | | magnetic particle |
| Treatment | | | | | of magnetic | | Residual magnetic |
| liquid | Component | Concentration | Component | Concentration | particles | Solvent | flux density |
| 1 | — | — | | | — | — | 11.0 kG |
| 2 | MgF₂ | 100 g/dm³ | LuF₃ | 50 g/dm³ | 20 mL | Methyl alcohol | 11.0 kG |
| 3 | MgF₂ | 100 g/dm³ | TmF₃ | 50 g/dm³ | 20 mL | Ethyl alcohol | 11.0 kG |
| 4 | MgF₂ | 75 g/dm³ | SmF₃ | 75 g/dm³ | 20 mL | Isopropyl alcohol | 10.9 kG |
| 5 | MgF₂ | 75 g/dm³ | DyF₃ | 75 g/dm³ | 20 mL | n-propyl alcohol | 11.0 kG |
| 6 | MgF₂ | 120 g/dm³ | HoF₃ | 30 g/dm³ | 20 mL | Acetone | 10.8 kG |
| 7 | LaF₃ | 50 g/dm³ | YbF₃ | 50 g/dm³ | 30 mL | Methyl alcohol | 11.1 kG |
| 8 | LaF₃ | 150 g/dm³ | HoF₃ | 150 g/dm³ | 10 mL | Ethyl alcohol | 11.0 kG |
| 9 | LaF₃ | 50 g/dm³ | TbF₃ | 100 g/dm³ | 20 mL | n-propyl alcohol | 11.1 kG |
| 10 | LaF₃ | 50 g/dm³ | EuF₃ | 50 g/dm³ | 30 mL | Isopropyl alcohol | 11.0 kG |
| 11 | CeF₃ | 50 g/dm³ | ErF₃ | 50 g/dm³ | 30 mL | Methyl alcohol | 11.0 kG |
| 12 | CeF₃ | 25 g/dm³ | DyF₃ | 75 g/dm³ | 30 mL | Ethyl alcohol | 11.1 kG |
| 13 | CeF₃ | 20 g/dm³ | CaF₃ | 180 g/dm³ | 15 mL | Isopropyl alcohol | 11.1 kG |
| 14 | PrF₃ | 20 g/dm³ | TbF₃ | 80 g/dm³ | 30 mL | Methyl alcohol | 11.1 kG |
| 15 | PrF₃ | 20 g/dm³ | DyF₃ | 80 g/dm³ | 30 mL | Methyl alcohol | 11.1 kG |
| 16 | PrF₃ | 10 g/dm³ | CaF₃ | 40 g/dm³ | 60 mL | Ethyl alcohol | 11.1 kG |
| 17 | NdF₃ | 20 g/dm³ | TbF₃ | 80 g/dm³ | 30 mL | Methyl alcohol | 11.0 kG |
| 18 | NdF₃ | 50 g/dm³ | HoF₃ | 50 g/dm³ | 30 mL | Methyl alcohol | 11.0 kG |
| 19 | NdF₃ | 15 g/dm³ | CaF₃ | 10 g/dm³ | 120 mL | Ethyl alcohol | 11.1 kG |
| 20 | NdF₃ | 10 g/dm³ | DyF₃ | 40 g/dm³ | 60 mL | Ethyl alcohol | 11.1 kG |
| 21 | NdF₃ | 50 g/dm³ | GdF₃ | 50 g/dm³ | 30 mL | Methyl alcohol | 11.0 kG |

| | |
|---|---|
| Magnetic properties of | |
| magnetic particle | Magnetic properties and resistivity of magnet |

| Treatment | Coercive | Maximum energy | Residual magnetic | Coercive | Maximum energy | |
|---|---|---|---|---|---|---|
| liquid | force | product | flux density | force | product | Resistivity |
| 1 | 15.0 kOe | 23.2 MGOe | 9.9 kG | 15.0 kOe | 18.8 MGOe | 0.15 mΩcm |
| 2 | 15.5 kOe | 23.6 MGOe | 9.9 kG | 15.5 kOe | 19.0 MGOe | 6.3 mΩcm |
| 3 | 15.5 kOe | 23.6 MGOe | 9.9 kG | 15.5 kOe | 19.1 MGOe | 11 mΩcm |
| 4 | 15.5 kOe | 22.8 MGOe | 9.8 kG | 15.5 kOe | 18.5 MGOe | 9.6 mΩcm |
| 5 | 16.5 kOe | 23.7 MGOe | 9.9 kG | 16.5 kOe | 19.2 MGOe | 8.5 mΩcm |
| 6 | 15.6 kOe | 22.4 MGOe | 9.7 kG | 15.6 kOe | 18.2 MGOe | 4.0 mΩcm |
| 7 | 15.9 kOe | 23.9 MGOe | 10.0 kG | 15.9 kOe | 19.4 MGOe | 18 mΩcm |
| 8 | 16.1 kOe | 23.9 MGOe | 10.0 kG | 16.1 KOe | 19.3 MGOe | 20 mΩcm |
| 9 | 17.3 kOe | 23.9 MGOe | 10.0 kG | 17.3 kOe | 19.4 MGOe | 15 mΩcm |
| 10 | 15.7 kOe | 23.5 MGOe | 9.9 kG | 15.7 kOe | 19.1 MGOe | 10 mΩcm |
| 11 | 15.5 kOe | 23.4 MGOe | 9.9 kG | 15.5 kOe | 19.0 MGOe | 19 mΩcm |
| 12 | 16.5 kOe | 23.8 MGOe | 10.0 kG | 16.5 kOe | 19.3 MGOe | 24 mΩcm |
| 13 | 16.1 kOe | 23.6 MGOe | 10.0 kG | 16.1 kOe | 19.2 MGOe | 18 mΩcm |
| 14 | 17.4 kOe | 23.7 MGOe | 10.0 kG | 17.4 kOe | 19.4 MGOe | 20 mΩcm |
| 15 | 16.5 kOe | 23.8 MGOe | 10.0 kG | 16.5 kOe | 19.3 MGOe | 19 mΩcm |
| 16 | 16.0 kOe | 23.6 MGOe | 10.0 kG | 16.0 kOe | 19.2 MGOe | 20 mΩcm |
| 17 | 17.5 kOe | 23.7 MGOe | 9.9 kG | 17.5 kOe | 19.2 MGOe | 28 mΩcm |
| 18 | 15.9 kOe | 23.6 MGOe | 9.9 kG | 15.9 kOe | 19.1 MGOe | 24 mΩcm |
| 19 | 16.2 kOe | 23.7 MGOe | 10.0 kG | 16.2 kOe | 19.2 MGOe | 26 mΩcm |
| 20 | 16.7 kOe | 23.9 MGOe | 10.0 kG | 16.7 kOe | 19.3 MGOe | 22 mΩcm |
| 21 | 16.7 kOe | 23.5 MGOe | 9.9 kG | 15.7 kOe | 19.1 MGOe | 23 mΩcm |

TABLE 4
Magnetic properties of magnets using magnetic particles with coating
films formed from rare earth fluoride and alkaline earth fluoride

| | | Treatment | | | | | |
|---|---|---|---|---|---|---|---|
| | | liquid to be | | | Magnetic properties of | | |
| | | added to 100 g | | | magnetic particle | | |
| Treatment | | of magnetic | | | Residual magnetic | Coercive | Maximum energy |
| liquid | Component | particles | Concentration | Solvent | flux density | force | product |
| 1 | — | — | — | — | 11.0 kG | 15.0 kOe | 23.2 MGOe |
| 2 | MgF₂ | 20 mL | 150 g/dm³ | Methyl alcohol | 10.8 kG | 15.5 kOe | 22.4 MGOe |
| 3 | CeF₃ | 20 mL | 150 g/dm³ | Methyl alcohol | 11.2 kG | 16.5 kOe | 24.0 MGOe |
| 4 | LaF₃ | 20 mL | 150 g/dm³ | Methyl alcohol | 11.3 kG | 16.5 kOe | 24.4 MGOe |
| 5 | LaF₃ | 20 mL | 150 g/dm³ | Ethyl alcohol | 11.2 kG | 16.4 kOe | 24.0 MGOe |
| 6 | LaF₃ | 20 mL | 150 g/dm³ | n-propyl alcohol | 11.2 kG | 16.2 kOe | 23.9 MGOe |
| 7 | LaF₃ | 20 mL | 150 g/dm³ | Isopropyl alcohol | 11.1 kG | 15.9 kOe | 23.6 MGOe |
| 8 | CeF₃ | 30 mL | 100 g/dm³ | Methyl alcohol | 11.0 kG | 15.5 kOe | 23.4 MGOe |
| 9 | PrF₃ | 30 mL | 100 g/dm³ | Methyl alcohol | 11.0 kG | 15.2 kOee | 23.3 MGOe |
| 10 | NdF₃ | 20 mL | 150 g/dm³ | Methyl alcohol | 11.0 kG | 16.0 kOe | 23.5 MGOe |
| 11 | SmF₃ | 20 mL | 150 g/dm³ | Methyl alcohol | 11.0 kG | 15.5 kOe | 23.4 MGOe |
| 12 | EuF₃ | 20 mL | 150 g/dm³ | Methyl alcohol | 11.0 kG | 15.5 kOe | 23.4 MGOe |
| 13 | GdF₃ | 20 mL | 150 g/dm³ | Methyl alcohol | 11.0 kG | 16.0 kOe | 23.6 MGOe |
| 14 | TbF₃ | 20 mL | 150 g/dm³ | Methyl alcohol | 11.1 kG | 18.0 kOe | 23.9 MGOe |
| 15 | DyF₃ | 20 mL | 150 g/dm³ | Methyl alcohol | 11.2 kG | 17.0 kOe | 24.2 MGOe |
| 16 | DyF₃ | 20 mL | 150 g/dm³ | Methyl alcohol | 11.2 kG | 17.5 kOe | 24.1 MGOe |
| | | | | 50 wt % + Water | | | |
| | | | | 50 wt % | | | |
| 17 | HoF₃ | 20 mL | 150 g/dm³ | Methyl alcohol | 11.0 kG | 15.8 kOe | 23.8 MGOe |
| 18 | ErF₃ | 20 mL | 150 g/dm³ | Methyl alcohol | 11.0 kG | 15.5 kOe | 23.5 MGOe |
| 19 | TmF₃ | 20 mL | 150 g/dm³ | Methyl alcohol | 11.2 kG | 15.5 kOe | 24.1 MGOe |
| 20 | VbF₃ | 20 mL | 150 g/dm³ | Methyl alcohol | 11.0 kG | 15.5 kOe | 23.5 MGOe |
| 21 | LuF₃ | 20 mL | 150 g/dm³ | Methyl alcohol | 11.2 kG | 15.5 kOe | 24.1 MGOe |

Magnetic properties and resistivity of magnet

| Treatment | Residual magnetic | Coercive | Maximum energy | |
|---|---|---|---|---|
| liquid | flux density | force | product | Resistivity |
| 1 | 9.9 kG | 15.0 kOe | 18.8 MGOe | 0.15 mΩcm |
| 2 | 9.7 kG | 15.5 kOe | 18.1 MGOe | 0.45 mΩcm |
| 3 | 10.1 kG | 16.5 kOe | 19.4 MGOe | 0.40 mΩcm |
| 4 | 10.2 kG | 16.5 kOe | 19.8 MGOe | 0.80 mΩcm |
| 5 | 10.1 kG | 16.4 kOe | 19.4 MGOe | 0.77 mΩcm |
| 6 | 10.1 kG | 16.2 kOe | 19.4 MGOe | 0.70 mΩcm |
| 7 | 10.0 kG | 15.9 kOe | 19.1 MGOe | 0.64 mΩcm |
| 8 | 9.9 kG | 15.5 kOe | 19.0 MGOe | 0.91 mΩcm |
| 9 | 9.9 kG | 15.2 kOe | 18.9 MGOe | 0.85 mΩcm |
| 10 | 9.9 kG | 16.0 kOe | 19.0 MGOe | 0.95 mΩcm |
| 11 | 9.9 kG | 15.5 kOe | 19.0 MGOe | 0.65 mΩcm |
| 12 | 9.9 kG | 15.5 kOe | 19.0 MGOe | 0.58 mΩcm |
| 13 | 9.9 kG | 16.0 kOe | 19.1 MGOe | 0.55 mΩcm |
| 14 | 10.0 kG | 18.0 kOe | 19.4 MGOe | 0.55 mΩcm |
| 15 | 10.1 kG | 17.0 kOe | 19.6 MGOe | 0.58 mΩcm |
| 16 | 10.1 kG | 17.5 kOe | 19.5 MGOe | 0.50 mΩcm |
| 17 | 9.9 kG | 15.8 kOe | 19.3 MGOe | 0.63 mΩcm |
| 18 | 9.9 kG | 15.5 kOe | 19.0 MGOe | 0.65 mΩcm |
| 19 | 10.1 kG | 15.5 kOe | 19.5 MGOe | 0.78 mΩcm |
| 20 | 9.9 kG | 15.5 kOe | 19.0 MGOe | 0.83 mΩcm |
| 21 | 10.1 kG | 15.5 kOe | 19.5 MGOe | 0.88 mΩcm |

The results clarified that magnetic particles with high-resistance coating films formed by use of various high-resistance coating film forming treatment liquids and anisotropic rare earth magnets formed by use of the magnetic particles have improved magnetic properties and increased the resistivity at least 20 times, as compared with magnetic particles without high-resistance coating films and anisotropic rare earth magnets formed by use of the magnetic particles. There were many types of magnetic particles and corresponding magnets having 100 times or more as high as the counterparts.

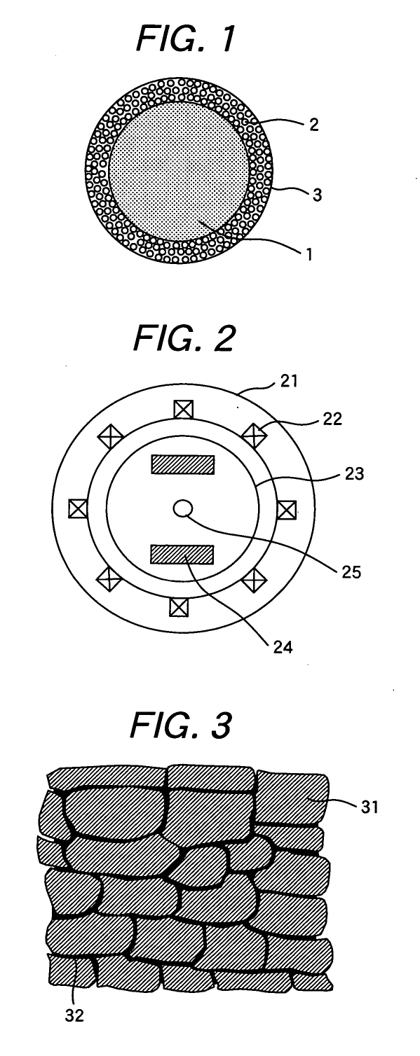

A cross section of a magnetic particle, for which heat treatment was performed in (4) above, in the high-resistance coating film was analyzed by use of a transmission electron microscope (TEM). As a result, on the surface of a rare earth magnet magnetic particle (NeFeB magnetic particle) indicated by 1 in FIG. 1, a particle, indicated by 2, the main component of which is low-reactivity rare earth fluoride, and a layer, indicated by 3, the main component of which is high-coatability rare earth fluoride, were detected. It was confirmed that although the high-coatability rare earth fluoride layer indicated by 3 included Nd that is assumed to have dispersed from the rare earth magnet magnetic particle and the low-reactivity rare earth fluoride component, the main component was high-coatability rare earth fluoride. For the particle, indicated by 2, the main component of which is low-reactivity rare earth fluoride, a clear electron diffraction pattern was obtained, crystallization was found, and a minute amount of high-coatability rare earth fluoride was also detected.

According to this embodiment, the weight ratio of low-reactivity rare earth fluoride to high-coatability rare earth fluoride is 0.25 to 9, both fluorides being included in the fluoride coating material.

### Second Embodiment

The solution prepared by the method described in the first embodiment was used as treatment liquid for forming a rare earth fluoride or alkaline earth metal fluoride coating film. In this embodiment, to prepare rare earth magnet magnetic particles, a hardener, the composition of which was adjusted, was cooled rapidly to fabricate NdFeB-based amorphous thin band. The amorphous thin band was then milled to magnetic particles. Specifically, a technique in which a single roll or twin rolls are used, such as the single-roll technique or twin-roll technique was used to dissolve the hardener on the surface of the rotating roller, and the hardener was cooled rapidly by expelling a jet of an inert gas such as an argon gas. The atmosphere is an inert gas atmosphere, reduction atmosphere, or vacuum atmosphere. The obtained thin band rapidly cooled is an amorphous substance or includes a crystalline material in an amorphous substance. The thin band was milled and classified so as to obtain an average particle diameter of 300 μm. When heated, magnetic particles including the amorphous substance is crystallized and magnetic particles the main phase of which is Nd₂Fe₁₄B are obtained.

Processes for forming high-resistance coating films on rare earth magnet magnetic particles were conducted by the method described below. In the following embodiment, a mixed solution in which 0.75 g/10 mL of MgF₂ and 0.75 g/10 mL of DyF₃ were mixed in an n-propyl alcohol solvent was used as high-resistance coating film forming treatment liquid.

(1) Ten mL of high-resistance coating film forming treatment liquid was added to 100 g of rare earth magnet magnetic particles having an average particle diameter of 300 μm. Mixing was performed until it was confirmed that the entire rare earth magnet magnetic particles were wetted.

(2) The rare earth magnet magnetic particles, obtained in (1), on which high-resistance coating films are formed, were placed under a reduced pressure of 2 to 5 torr to remove the n-propyl alcohol solvent.

(3) The rare earth magnet magnetic particles from which the solvent was removed in (2) was moved to a quartz board, and then heated at 200° C. for 30 minutes and at 400° C. for 30 minutes, under a reduced pressure of 1×10⁻⁵ torr.

(4) Ten mL of high-resistance coating film forming treatment liquid was added to the magnetic particles heated in (3). Mixing was performed until it was confirmed that the entire rare earth magnet magnetic particles were wetted.

(5) The rare earth magnet magnetic particles, obtained in (4), on which high-resistance coating films are formed, were placed under a reduced pressure of 2 to 5 torr to remove the n-propyl alcohol solvent.

(6) The rare earth magnet magnetic particles from which the solvent was removed in (5) was moved to a quartz board, and then heated at 200° C. for 30 minutes and at 400° C. for 30 minutes, under a reduced pressure of 1×10-5 torr.

(7) The magnetic particles, for which heat treatment was performed in (6), was moved to a covered container made of Macor (from Riken Denshi, Co., Ltd.), and then heated at 700° C. for 30 minutes under a reduced pressure of 1×10⁻⁵ torr.

(8) The rare earth magnet magnetic particles, for which heat treatment was performed in (7), was mixed with solid epoxy resin (EPX6136 from SOMAR CORP.) with a size of 100 μm or less by using a V mixer so that the volume became 10%.

(9) The magnetic properties of the rare earth magnetic particles, for which heat treatment were performed in (7), was investigated.

(10) A compound of the rare earth magnet magnetic particles prepared in (8) and resin was loaded into a metal mold, and orientation was performed in a 10-kOe magnetic field in an inert gas atmosphere. Then, heated compression molding was performed at 70° C. under a molding pressure of 5 t/cm². A bond magnet measuring 7 mm×7 mm×5 mm was fabricated.

(11) The resin hardening in the bond magnet fabricated in (10) was carried out in a nitrogen gas at 170° C. for one hour.

(12) A pulse magnetic field at 30 kOe or more was applied to the bond magnet fabricated in (11). The magnetic properties of the magnet were then investigated.

Table 3 shows results obtained by investigating the magnetic properties of magnets and magnetic particles fabricated in processes (1) to (12) above by using other high-resistance coating film forming treatment liquids. At the line 1 in Table 3, a sintered magnet fabricated from magnetic particles without high-resistance coating films is shown. For comparison purposes, Table 5 shows the properties of a bond magnet fabricated from magnetic particles with coating films formed from only one type of fluoride.

The results clarified that rapidly cooled magnetic particles with high-resistance coating films formed by use of various high-resistance coating film forming treatment liquids and rare earth bond magnets formed by use of the magnetic particles have improved magnetic properties and increased resistivity at least 20 times, as compared with rapidly cooled magnetic particles without high-resistance coating films and rare earth bond magnets formed by use of the magnetic particles. There were many types of rapidly cooled magnetic particles and corresponding magnets having 100 times or more as high as the counterparts.

TABLE 3
Magnetic properties of magnets using magnetic particles with coating
films formed from rare earth fluoride and alkaline earth fluoride

| | | | | | Treatment | | |
|---|---|---|---|---|---|---|---|
| | | | | | liquid to be | | Magnetic properties of |
| | | | | | added to 100 g | | magnetic particle |
| Treatment | | | | | of magnetic | | Residual magnetic |
| liquid | Component | Concentration | Component | Concentration | particles | Solvent | flux density |
| 1 | — | — | | | — | — | 6.5 kG |
| 2 | MgF₂ | 100 g/dm³ | LuF₃ | 50 g/dm³ | 20 mL | Methyl alcohol | 6.6 kG |
| 3 | MgF₂ | 100 g/dm³ | TmF₃ | 50 g/dm³ | 20 mL | Ethyl alcohol | 6.6 kG |
| 4 | MgF₂ | 75 g/dm³ | SmF₃ | 75 g/dm³ | 20 mL | Isopropyl alcohol | 6.6 kG |
| 5 | MgF₂ | 75 g/dm³ | DyF₃ | 75 g/dm³ | 20 mL | n-propyl alcohol | 6.8 kG |
| 6 | MgF₂ | 120 g/dm³ | HoF₃ | 30 g/dm³ | 20 mL | Acetone | 6.7 kG |
| 7 | LaF₃ | 50 g/dm³ | YbF₃ | 50 g/dm³ | 30 mL | Methyl alcohol | 6.9 kG |
| 8 | LaF₃ | 150 g/dm³ | HoF₃ | 150 g/dm³ | 10 mL | Ethyl alcohol | 6.9 kG |
| 9 | LaF₃ | 50 g/dm³ | TbF₃ | 100 g/dm³ | 20 mL | n-propyl alcohol | 6.9 kG |
| 10 | LaF₃ | 50 g/dm³ | EuF₃ | 50 g/dm³ | 30 mL | Isopropyl alcohol | 6.7 kG |
| 11 | CeF₃ | 50 g/dm³ | ErF₃ | 50 g/dm³ | 30 mL | Methyl alcohol | 6.7 kG |
| 12 | CeF₃ | 25 g/dm³ | DyF₃ | 75 g/dm³ | 30 mL | Ethyl alcohol | 6.9 kG |
| 13 | CeF₃ | 20 g/dm³ | CaF₃ | 180 g/dm³ | 15 mL | Isopropyl alcohol | 6.5 kG |
| 14 | PrF₃ | 20 g/dm³ | TbF₃ | 80 g/dm³ | 30 mL | Methyl alcohol | 6.8 kG |
| 15 | PrF₃ | 20 g/dm³ | DyF₃ | 80 g/dm³ | 30 mL | Methyl alcohol | 6.9 kG |
| 16 | PrF₃ | 10 g/dm³ | CaF₃ | 40 g/dm³ | 60 mL | Ethyl alcohol | 6.5 kG |
| 17 | NdF₃ | 20 g/dm³ | TbF₃ | 80 g/dm³ | 30 mL | Methyl alcohol | 6.8 kG |
| 18 | NdF₃ | 50 g/dm³ | HoF₃ | 50 g/dm³ | 30 mL | Methyl alcohol | 6.9 kG |
| 19 | NdF₃ | 15 g/dm³ | CaF₃ | 10 g/dm³ | 120 mL | Ethyl alcohol | 6.6 kG |
| 20 | NdF₃ | 10 g/dm³ | DyF₃ | 40 g/dm³ | 60 mL | Ethyl alcohol | 6.9 kG |
| 21 | NdF₃ | 50 g/dm³ | GdF₃ | 50 g/dm³ | 30 mL | Methyl alcohol | 6.7 kG |

| | |
|---|---|
| Magnetic properties of | |
| magnetic particle | Magnetic properties and resistivity of magnet |

| Treatment | Coercive | Maximum energy | Residual magnetic | Coercive | Maximum energy | |
|---|---|---|---|---|---|---|
| liquid | force | product | flux density | force | product | Resistivity |
| 1 | 12.0 kOe | 10.5 MGOe | 5.7 kG | 12.0 kOe | 8.1 MGOe | 5.6 mΩcm |
| 2 | 13.2 kOe | 11.0 MGOe | 5.7 kG | 13.2 kOe | 8.3 MGOe | 380 mΩcm |
| 3 | 13.1 kOe | 11.0 MGOe | 5.7 kG | 13.1 kOe | 8.3 MGOe | 1800 mΩcm |
| 4 | 12.7 kOe | 10.8 MGOe | 5.7 kG | 12.7 kOe | 8.2 MGOe | 1100 mΩcm |
| 5 | 13.7 kOe | 11.2 MGOe | 5.9 kG | 13.7 kOe | 8.5 MGOe | 780 mΩcm |
| 6 | 12.8 kOe | 10.8 MGOe | 5.8 kG | 12.8 kOe | 8.2 MGOe | 110 mΩcm |
| 7 | 14.3 kOe | 11.8 MGOe | 6.0 kG | 14.3 kOe | 9.1 MGOe | 5500 mΩcm |
| 8 | 14.2 kOe | 11.8 MGOe | 6.0 kG | 14.2 kOe | 9.1 MGOe | 6200 mΩcm |
| 9 | 14.0 kOe | 11.6 MGOe | 6.0 kG | 14.0 kOe | 8.9 MGOe | 2500 mΩcm |
| 10 | 13.4 kOe | 10.9 MGOe | 5.9 kG | 13.4 kOe | 8.5 MGOe | 1500 mΩcm |
| 11 | 13.6 kOe | 11.0 MGOe | 5.8 kG | 13.6 kOe | 8.4 MGOe | 5800 mΩcm |
| 12 | 14.1 kOe | 11.6 MGOe | 6.0 kG | 14.1 kOe | 8.9 MGOe | 8600 mΩcm |
| 13 | 12.9 kOe | 10.6 MGOe | 5.7 kG | 12.9 kOe | 8.2 MGOe | 5400 mΩcm |
| 14 | 13.7 kOe | 11.1 MGOe | 5.9 kG | 13.7 kOe | 8.5 MGOe | 6100 mΩcm |
| 15 | 14.3 kOe | 11.7 MGOe | 6.0 kG | 14.3 kOe | 9.0 MGOe | 5700 mΩcm |
| 16 | 13.0 kOe | 10.6 MGOe | 5.7 kG | 13.0 kOe | 8.2 MGOe | 6200 mΩcm |
| 17 | 13.9 kOe | 11.2 MGOe | 5.9 kG | 13.9 kOe | 8.6 MGOe | 1100 mΩcm |
| 18 | 13.8 kOe | 11.2 MGOe | 6.0 kG | 13.8 kOe | 8.8 MGOe | 8700 mΩcm |
| 19 | 13.1 kOe | 11.0 MGOe | 5.8 kG | 13.1 kOe | 8.3 MGOe | 10000 mΩcm |
| 20 | 14.5 kOe | 11.7 MGOe | 6.0 kG | 14.5 kOe | 9.0 MGOe | 7300 mΩcm |
| 21 | 13.4 kOe | 10.9 MGOe | 5.8 kG | 13.4 kOe | 8.4 MGOe | 7700 mΩcm |

TABLE 5
Magnetic properties of magnets using magnetic particles with coating
films formed from rare earth fluoride and alkaline earth fluoride

| | | Treatment | | | | | |
|---|---|---|---|---|---|---|---|
| | | liquid to be | | | Magnetic properties of | | |
| | | added to 100 g | | | magnetic particle | | |
| Treatment | | of magnetic | | | Residual magnetic | Coercive | Maximum energy |
| liquid | Component | particles | Concentration | Solvent | flux density | force | product |
| 1 | — | — | — | — | 6.5 kG | 12.0 kOe | 10.5 MGOe |
| 2 | MgF₂ | 10 mL | 300 g/dm³ | Methyl alcohol | 6.6 kG | 12.5 kOe | 10.8 MGOe |
| 3 | CeF₃ | 10 mL | 300 g/dm³ | Methyl alcohol | 6.5 kG | 12.9 kOe | 10.6 MGOe |
| 4 | LaF₃ | 10 mL | 300 g/dm³ | Methyl alcohol | 7.0 kG | 14.3 kOe | 12.0 MGOe |
| 5 | LaF₃ | 10 mL | 300 g/dm³ | Ethyl alcohol | 6.9 kG | 14.2 kOe | 11.7 MGOe |
| 6 | LaF₃ | 10 mL | 300 g/dm³ | n-propyl alcohol | 6.9 kG | 14.0 kOe | 11.6 MGOe |
| 7 | LaF₃ | 10 mL | 300 g/dm³ | Isopropyl alcohol | 6.8 kG | 13.8 kOe | 11.2 MGOe |
| 8 | CeF₃ | 30 mL | 100 g/dm³ | Methyl alcohol | 6.7 kG | 12.9 kOe | 10.7 MGOe |
| 9 | PrF₃ | 30 mL | 100 g/dm³ | Methyl alcohol | 6.7 kG | 13.3 kOe | 10.7 MGOe |
| 10 | NdF₃ | 15 mL | 200 g/dm³ | Methyl alcohol | 6.8 kG | 13.5 kOe | 10.9 MGOe |
| 11 | SmF₃ | 15 mL | 200 g/dm³ | Methyl alcohol | 6.7 kG | 13.1 kOe | 10.8 MGOe |
| 12 | EuF₃ | 15 mL | 200 g/dm³ | Methyl alcohol | 6.7 kG | 13.2 kOe | 10.8 MGOe |
| 13 | GdF₃ | 15 mL | 200 g/dm³ | Methyl alcohol | 6.8 kG | 13.4 kOe | 11.0 MGOe |
| 14 | TbF₃ | 10 mL | 300 g/dm³ | Methyl alcohol | 6.9 kG | 14.1 kOe | 11.6 MGOe |
| 15 | DyF₃ | 10 mL | 300 g/dm³ | Methyl alcohol | 7.0 kG | 15.0 kOe | 12.1 MGOe |
| 16 | DyF₃ | 15 mL | 200 g/dm³ | Methyl alcohol | 7.0 kG | 15.2 kOe | 12.2 MGOe |
| | | | | 50 wt % + Water | | | |
| | | | | 50 wt % | | | |
| 17 | HoF₃ | 20 mL | 150 g/dm³ | Methyl alcohol | 7.0 kG | 14.3 kOe | 12.0 MGOe |
| 18 | ErF₃ | 15 mL | 200 g/dm³ | Methyl alcohol | 6.8 kG | 14.5 kOe | 11.7 MGOe |
| 19 | TmF₃ | 15 mL | 200 g/dm³ | Methyl alcohol | 6.8 kG | 14.4 kOe | 11.6 MGOe |
| 20 | YbF₃ | 15 mL | 200 g/dm³ | Methyl alcohol | 6.8 kG | 14.3 kOe | 11.3 MGOe |
| 21 | LuF₃ | 15 mL | 200 g/dm³ | Methyl alcohol | 6.8 kG | 14.3 kOe | 11.2 MGOe |

Magnetic properties and resistivity of magnet

| Treatment | Residual magnetic | Coercive | Maximum energy | |
|---|---|---|---|---|
| liquid | flux density | force | product | Resistivity |
| 1 | 5.7 kG | 12.0 kOe | 8.1 MGOe | 5.6 mΩcm |
| 2 | 5.7 kG | 12.5 kOe | 8.3 MGOe | 50 mΩcm |
| 3 | 5.7 kG | 12.9 kOe | 8.2 MGOe | 40 mΩcm |
| 4 | 6.1 kG | 14.3 kOe | 9.2 MGOe | 160 mΩcm |
| 5 | 6.0 kG | 14.2 kOe | 9.0 MGOe | 150 mΩcm |
| 6 | 6.0 kG | 14.0 kOe | 8.9 MGOe | 120 mΩcm |
| 7 | 5.9 kG | 13.8 kOe | 8.6 MGOe | 100 mΩcm |
| 8 | 5.8 kG | 12.9 kOe | 8.2 MGOe | 210 mΩcm |
| 9 | 5.8 kG | 13.3 kOe | 8.2 MGOe | 180 mΩcm |
| 10 | 5.9 kG | 13.5 kOe | 8.4 MGOe | 220 mΩcm |
| 11 | 5.8 kG | 13.1 kOe | 8.3 MGOe | 110 mΩcm |
| 12 | 5.8 kG | 13.2 kOe | 8.3 MGOe | 84 mΩcm |
| 13 | 5.9 kG | 13.4 kOe | 8.5 MGOe | 75 mΩcm |
| 14 | 6.0 kG | 14.1 kOe | 8.9 MGOe | 75 mΩcm |
| 15 | 6.1 kG | 15.0 kOe | 9.3 MGOe | 84 mΩcm |
| 16 | 6.1 kG | 15.2 kOe | 9.4 MGOe | 62 mΩcm |
| 17 | 6.1 kG | 14.3 kOe | 9.2 MGOe | 99 mΩcm |
| 18 | 5.9 kG | 14.5 kOe | 9.0 MGOe | 110 mΩcm |
| 19 | 5.9 kG | 14.4 kOe | 8.9 MGOe | 150 mΩcm |
| 20 | 5.9 kG | 14.3 kOe | 8.6 MGOe | 170 mΩcm |
| 21 | 5.9 kG | 14.3 kOe | 8.6 MGOe | 190 mΩcm |

A cross section of a magnetic particle, for which heat treatment was performed in (7) above, in the high-resistance coating film was analyzed by use of a TEM. As a result, on the surface of a rare earth magnet magnetic particle (NeFeB magnetic particle) indicated by 1 in the conceptual diagram in FIG. 1, a particle, indicated by 2, the main component of which is low-reactivity rare earth fluoride, and a layer, indicated by 3, the main component of which is high-coatability rare earth fluoride, were detected. It was confirmed that although the high-coatability rare earth fluoride layer indicated by 3 included Nd that is assumed to have dispersed from the rare earth magnet magnetic particle and the low-reactivity rare earth fluoride component, the main component was high-coatability rare earth fluoride. For the particle, indicated by 2, the main component of which is low-reactivity rare earth fluoride, a clear electron diffraction pattern was obtained, crystallization was found, and a minute amount of high-coatability rare earth fluoride was also detected.

As described above, magnetic particles having high-resistance coating films with a thickness of a μm level to a nm level, which are formed on the surfaces by use of high-resistance coating film forming treatment liquid, and a magnet fabricated from these magnetic particles are superior in magnetic properties and electric properties to magnetic particles on which coating films are not formed and a magnet fabricated from these magnetic particles. Particularly, the magnet resistivity is about 100 times higher.

FIG. 3 shows the actual shape of the internal structure of a magnet as the embodiment of the present invention. Reference numeral 31 indicates a magnetic particle, and reference numeral 32 indicates a fluoride film.

The weight ratio of low-reactivity rare earth fluoride to high-coatability rare earth fluoride is 0.25 to 9, both fluorides being included in the fluoride coating film.

### Third Embodiment

FIG. 2 shows a rotating machine that uses the embodiments described above. The rotating machine can be used as not only a motor but also a power generator. In FIG. 2, a stator 21 has slots, in each of which a coil 22 is wound. A rotor 23 is fixed to a shaft 25; magnets 24 described in the above embodiments are embedded in the rotor. This embodiment can provide a highly efficient rotating machine with less loss because the high resistivity of the magnets can reduce the eddy current that flows in the magnets in the rotor of the rotating machine.

The present invention can reduce eddy current in an R—Fe—B (R is a rare earth element) or R—Co magnet by forming insulating coating films on the surfaces of particles that are materials of a magnet. Accordingly, as for a rare earth magnet fabricated by use of rare earth magnet magnetic particles or soft magnetic particles having coating films according to the present invention, the eddy current loss, which is generated in a magnet exposed to a varying magnetic field such as an AC magnetic field, can be suppressed, thereby reducing the heat loss caused by the eddy current loss. The present invention can be then applied to a rotating machine such as a motor having magnets on the surface or embedded magnets as well as an MRI apparatus in which magnets are placed in a high frequency magnetic field.

What is claimed is:

1. A magnet, wherein a surface of each of magnetic particles constituting the magnet is covered by a film with two or more types of fluoride are main components.

2. A magnet according to claim 1, wherein the main components of the film are fluoride including an element selected from the group consisting of Mg, La, Ce, Pr and Nd and fluoride including an element selected from the group consisting of Ca, Sr, Ba, Sm, Eu, Gd, Tb, Dy, Ho, Er, Tm, Yb, or Lu; the fluoride including an element selected from the group consisting of Ca, Sr, Ba, Sm, Eu, Gd, Tb, Dy, Ho, Er, Tm, Yb, or Lu is dispersed into the fluoride including an element selected from the group consisting of Mg, La, Ce, Pr and Nd.

3. A magnet according to claim 1, wherein the main components of the film are fluoride including an element selected from the group consisting of Mg, La, Ce, Pr or Nd and fluoride including an element selected from the group consisting of Ca, Sr, Ba, Sm, Eu, Gd, Tb, Dy, Ho, Er, Tm, Yb, or Lu.

4. A magnet according to claim 1, wherein an average film thickness of the film is 1 μm or less.

5. A magnet according to claim 1, wherein the main component of the magnetic particle is R—Fe—B (R is a rare earth element) or R—Co.

6. A magnet according to claim 2, wherein the main component of the magnetic particle is Nd—Fe—B.

7. A magnet according to claim 6, wherein a weight ratio of an amount of the fluoride including an element selected from the group consisting of Ca, Sr, Ba, Sm, Eu, Gd, Tb, Dy, Ho, Er, Tm, Yb, or Lu to an amount of the fluoride including an element selected from the group consisting of Mg, La, Ce, Pr or Nd is 0.25 to 9, both fluorides being included in the film on the surface of the magnetic particle.

8. A magnetic material for a magnet includes magnetic particles, wherein a film with main components thereof are fluoride including an element selected from the group consisting of Mg, La, Ce, Pr or Nd and fluoride including an element selected from the group consisting of Ca, Sr, Ba, Sm, Eu, Gd, Tb, Dy, Ho, Er, Tm, Yb, or Lu, is formed on a surface of each of the magnetic particles.

9. A magnetic material according to claim 8, wherein an average film thickness of the film is 1 μm or less.

10. A magnetic material according to claim 8, wherein the main component of the magnetic particle is R—Fe—B (R is a rare earth element) or R—Co.

11. A magnetic material according to claim 10, wherein the main component of the magnetic particle is Nd—Fe—B.

12. Coating film forming treatment liquid, wherein the coating film forming treatment liquid is prepared by dispersing at least two types of fluoride in an solvent; the at least two types of fluoride is fluoride including an element selected from the group consisting of Mg, La, Ce, Pr or Nd and fluoride including an element selected from the group consisting of Ca, Sr, Ba, Sm, Eu, Gd, Tb, Dy, Ho, Er, Tm, Yb, or Lu, the at least two types of fluoride are mixed with each other; the solvent is selected from the group consisting of alcohols and ketones.

13. Coating film forming treatment liquid according to claim 12, wherein the number of carbons in the solvent is 4 or less.

14. Coating film forming treatment liquid according to claim 12, wherein the solvent is selected from the group consisting of methyl alcohol, ethyl alcohol, n-propyl alcohol, isopropyl alcohol, acetone, and 2-butanone.

15. Coating film forming treatment liquid according to claim 12, wherein, in the alcohols or ketones, a concentration of the fluoride including an element selected from the group consisting of Mg, La, Ce, Pr or Nd is 10 g/dm³ to 150 g/dm³, and a concentration of the fluoride including an element selected from the group consisting of Ca, Sr, Ba, Sm, Eu, Gd, Tb, Dy, Ho, Er, Tm, Yb, or Lu is 10 g/dm³ to 180 g/dm³.

16. A rotating machine having a rotor, a stator and a plurality magnets, the stator including a plurality of slots, in each of which a coil is wound, wherein each of the plurality of magnets is a lump of magnetic particles, and a film including two or more types of fluoride is formed on a surface of each of the plurality of magnetic particles.
